(19) United States
(12) Patent Application Publication
(10) Pub. No.: US 2010/0160590 A1
(43) Pub. Date: Jun. 24, 2010

(54) SILICONE RESINS HAVING A DEFINED REACTIVITY

(75) Inventors: Frank Sandmeyer, Burgkirchen (DE); Hans Mayer, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/993,231

(22) PCT Filed: Jun. 22, 2006
(86) PCT No.: PCT/EP06/06021

§ 371 Date: Dec. 20, 2007

(30) Foreign Application Priority Data
Jun. 30, 2005 (DE) 10 2005 030 579.2

(51) Int. Cl. C08G 77/00

(52) U.S. Cl. 528/10

(57) ABSTRACT

Reactivity of silicone resins containing silanol functionality is enhanced by including HCl in the resin.

The invention relates to silicone resins and to a process for preparing them.

According to DE 195 07 594 A1 the reactivity of a silicone resin can be controlled by using steam treatment to replace the alkoxy groups of the silicone resin that contains slow-to-react alkoxy groups by silicone-bonded hydroxyl groups.

Other approaches to the preparation of OH-rich silicone resins of adapted reactivity are given in U.S. Pat. No. 2,832,794 and U.S. Pat. No. 3,489,782.
Here there are in each case specific process parameters to be observed, which lead to separate, specific products through which the required reactivity control is made possible.

It is an object of the invention to improve on the prior art and more particularly to prepare silicone resins whose reactivity is controlled by a parameter which is independent of the silanol content of the silicone resin. This object is achieved by means of the invention.

The invention provides a silicone resin composed of repeating units of the general formula (1)

[A¹_{z}R¹ₚSiO_{(4-p-z)/2}] (1)

where z and p each denote an integer of value 0-3, A¹ denotes identical or different hydrogen, alkyl, cycloalkyl, aryl or alkoxy radicals having an aliphatic linear or branched or a cycloaliphatic alkyl radical or an aryloxy radical, or denotes a functional radical which contains up to 18 C atoms and may further include one or more identical or different heteroatoms selected from O, S, Si, Cl, F, Br, P, and N atoms,
where
   R¹ denotes identical or different aliphatic or cycloaliphatic alkoxy, aryloxy or hydroxyl radicals or denotes a radical Al,
   where there must at least be either T or Q units or both present, and there may additionally be M and/or D units present, and the silicone resin is characterized in that it comprises at least 1 ppm of HCl.

Preferred silicone resins are those having a molecular weight average between 800 and 500 000.

The amount of HCl is set in accordance with the desired reactivity; in accordance with the invention there is at least 1 ppm of HCl present, and the amount of HCl is preferably from 1 ppm to 10% by weight based on resin. Preferably, however, there are 1 ppm to 5% by weight, with particular preference 1 ppm to 3% by weight, amounts of HCl present.

The invention further provides a process for preparing a silicone resin, where the synthesis takes place starting from silanes and/or siloxanes which contain hydrolyzable groups, and the synthesis comprises the steps of hydrolysis and condensation, and either the hydrolyzable groups are silicon-bonded chlorine atoms or silicon-bonded alkoxy groups, aryloxy or hydroxyl groups, where HCl in gas form or in solution in water is used in one step of the resin preparation, and the amount of HCl is set in accordance with the desired reactivity, and HCl added in excess is removed.

The amount of HCl added in excess can be removed by neutralizing or other prior-art methods, such as expulsion in gas form through the application of reduced pressure, or heating in those cases where the acid is a product which is gaseous per se, such as HCl, for instance.

The silicone resins of the invention are used preferably as binders for producing coatings. Depending on HCl content, the silicone resins of the invention surprisingly possess a more or less high reactivity. They endow coatings in which they are employed as binders with excellent resistance properties, in the face for example of effects of weathering, attack by chemical influences, and UV radiation. With these coatings it is also possible to realize very good water resistance and low soiling propensity. With hydrophobically formulated copolymers, moreover, it is possible to realize porous coatings, having pigment volume concentration above the critical pigment volume concentration, which are distinguished by excellent gas and water vapor permeability at the same time as a high water repellency. The polymerization and incorporation of silanes containing hydrolyzable and condensable groups in the copolymer makes it possible to prepare binders which, following application, are moisture-curing, with the result it is possible to adjust the film hardnesses, the thermoplasticity, and the soiling propensity.

As well as for this purpose, the silicone resins of the invention can also be used as additive-type additions to preparations for coatings or other purposes, and also, without further adjuvants, as pure material forming films over substrates or curing to form blocks or any other desired shapes.

Further properties which can be manipulated through the use of the silicone resins of the invention, either alone or in combination with or as a constituent of other preparations, are, for example:
controlling the electrical conductivity and electrical resistance
controlling the leveling properties
stabilizing or destabilizing foam
controlling the gloss of a wet or cured film or of an object
increasing the weathering resistance
increasing the chemical resistance
increasing the shade stability
reducing the chalking propensity
reducing or increasing the static friction and sliding friction on solid bodies or films obtained from preparations comprising the dispersion of the invention
improving the wet adhesion
improving the wet abrasion resistance
improving the adhesion to substrates
improving the intercoat adhesion between two substrates, films, etc.
controlling the filler and pigment wetting and dispersing behavior,
controlling the rheological properties
controlling the mechanical properties, such as flexibility, scratch resistance, elasticity, extensibility, bendability, tensile behavior, rebound behavior, hardness, density, tear propagation resistance, compression set, behavior at different temperatures, expansion coefficient, abrasion resistance, and other properties, such as thermal conductivity, combustibility, gas permeability, resistance to water vapor, hot air, chemicals, weathering, and radiation, sterilizability, for example, of solid bodies or films obtainable from the preparation comprising the dispersion of the invention
controlling electrical properties, such as dielectric loss factor, breakdown resistance, dielectric constant, creep current resistance, light arc resistance, surface resistance, specific breakdown resistance, for example.

Examples of fields of application in which the silicone resins of the invention allow the properties identified above to be manipulated are the preparation of coating materials and impregnation systems, and coatings and coverings obtained therefrom on substrates, such as metal, glass, wood, mineral substrate, synthetic fibers and natural fibers for producing textiles, carpets, floor coverings, or other goods which can be produced from fibers, leather, plastics such as films, and moldings. The silicone resins of the invention can be incorporated in liquid or in cured solid form into elastomer compounds. In this context they can be used for the purpose of reinforcing or improving other service properties such as the control of transparency, of heat resistance, of yellowing propensity, and of weathering resistance.

### EXAMPLE

A methylsilicone resin composed of 87% units of the formula Me-Si(O)3/2 and 13% units of the formula Me2Si(O)2/2, which additionally possess 5.8 percent by weight of ethoxy groups and 0.9 percent by weight of OH groups on the surface, was dissolved in toluene to give a 50% strength solution. This mixture, which contained 0.02 percent by weight of hydrochloric acid, was admixed with dilute aqueous hydrochloric acid, to give a concentration series.

The following hydrochloric acid concentrations were set:

8.78% by weight HCl based on resin solids (i.e., for a 50% strength resin solution, the FIG. 8.78% by weight for 100 g of this resin preparation refers to the 50 g of resin it contains)
1.61% by weight HCl based on resin solids
1.57% by weight HCl based on resin solids

These samples were stored at 50° C. and observed to ascertain the time after which hazing comes about as a result of the condensation of the resin molecules contained, in other words the commencement of crosslinking.

The times obtained were as follows:
with 0.02% by weight HCl: 96 h
with 1.57% by weight HCl: 34 h
with 1.61% by weight HCl: 28 h
with 8.78% by weight HCl: 8 h.

1.-2. (canceled)

3. A silicone resin composed of repeating units of the formula (1)
[A¹_{z}R¹ₚSiO_{(4-p-z)/2}] (1)
where z and p are each integers from 0-3,
A¹ are identical or different, and are hydrogen, alkyl radicals, cycloalkyl radicals, aryl radicals, alkoxy radicals having a linear or branched aliphatic or cycloaliphatic alkyl radical, or an aryloxy radical, or are a functional radical which contains up to 18 C atoms optionally including one or more identical or different heteroatoms selected from O, S, Si, Cl, F, Br, P, and N atoms,
where
R¹ are identical or different aliphatic or cycloaliphatic alkoxy, aryloxy or hydroxyl radicals or are a radical A¹,
wherein T or Q units or both T and Q units present, and optionally M and/or D units, and the silicone resin contains at least 1 ppm of HCl.

4. The resin of claim 3 which contains 1 ppm to 10% by weight HCl.

5. The resin of claim 3, which contains 0.02 to 10% by weight HCl.

6. The resin of claim 3, which contains 1.57 to 10% by weight HCl.

7. In a process for preparing a silicone resin of claim 3, wherein the synthesis takes place starting from silanes and/or siloxanes which contain hydrolyzable groups, and the synthesis comprises the steps of hydrolysis and condensation, and either the hydrolyzable groups are silicon-bonded chlorine atoms or silicon-bonded alkoxy groups, aryloxy or hydroxyl groups, the improvement comprising supplying HCl in gas form or in solution in water in at least one step of resin preparation, setting the amount of HCl in accordance with a desired reactivity, and removing HCl added in excess.
